(19) United States
(12) Patent Application Publication
(10) Pub. No.: US 2026/0221843 A1
(43) Pub. Date: Jul. 30, 2026

(54) MOTOR AND VEHICLE POWER SYSTEM

(71) Applicant: Schaeffler Technologies AG & Co. KG, Herzogenaurach (DE)

(72) Inventor: Huachao Qiu, Shanghai (CN)

(21) Appl. No.: 19/131,450

(22) PCT Filed: Nov. 13, 2023
(86) PCT No.: PCT/CN2023/131224

§ 371 Date: May 20, 2025

(30) Foreign Application Priority Data
Nov. 23, 2022 (CN) 202211477090.4

(51) Int. Cl. H02K 9/193; B60K 1/00; B60K 6/26; H02K 1/20; H02K 5/20

(52) U.S. Cl. CPC H02K 9/193; H02K 1/20; H02K 5/203; B60K 1/00; B60K 6/26

(57) ABSTRACT

A motor includes a housing including a main body portion and covers; an iron core fixed to the housing and provided with mounting holes; a winding mounted in the mounting holes and including extending parts; and seal rings located in the housing. The seal rings have end edges of two axial sides respectively abutting against the iron core and the covers. The outer periphery abuts against the main body portion. The seal rings, the main body portion and the iron core defining a space that is in communication with the mounting holes, the space continuously extending along the circumferential direction over the entire circumference. In this way, a cooling fluid cools a stator.

### CROSS-REFERENCE TO RELATED APPLICATIONS

The present application is the U.S. National Phase of PCT Patent Application Number PCT/CN2023/131224, filed on Nov. 13, 2023, which claims priority to Chinese Patent Application Number 202211477090.4, filed Nov. 23, 2022, the entire disclosures of which are incorporated by reference herein.

### TECHNICAL FIELD

The present application relates to the field of motors, and in particular to a motor having a cooling structure and a vehicle power system comprising the motor.

### BACKGROUND

Nowadays, motors are often used as power sources for outputting torque, and cooling of the motors is very important to allow the motors to output the specified torque. In a motor cooling structure in the prior art, the motor cooling structure is designed to be in close contact with the outer peripheral surface of a stator iron core. A cooling fluid (for example, a cooling water) flowing in the motor cooling structure can take away heat from the stator iron core to effectuate cooling. In another motor cooling structure in the prior art, the motor cooling structure is designed to have a nozzle to spray a cooling fluid (for example, a cooling oil) directly onto a stator to take away heat.

However, in one of the motor cooling structures described above, the cooling fluid effectuates indirect cooling of the stator iron core. This cooling structure sometimes provides insufficient cooling for the stator iron core, and is even less desirable for the cooling effect of a stator winding that is not in contact with the motor cooling structure. In the other motor cooling structure described above, the nozzle is used to spray the cooling fluid onto two end portions of the stator winding extending from the stator iron core, thereby directly cooling the two end portions of the stator winding. Although this cooling structure can improve the cooling effect compared to the former, the cooling effect on the motor stator is still insufficient.

### SUMMARY

The present application has been made in view of the state of the prior art as described above. It is an object of the present application to provide a motor. A cooling structure of the motor can fully and effectively cool a stator, thereby reducing adverse effects on the performance of the motor caused by an over-high temperature of the stator in a working process of the motor. It is a further object of the present application to provide a vehicle power system comprising the motor.

To achieve the foregoing objects, the following technical solutions are used in the present application.

The present application provides a motor, comprising:
a housing comprising a main body portion and covers, the main body portion having a cylindrical shape, and the covers being fixed to the main body portion and closing an axial opening of the main body portion;
an iron core which is located in the housing and fixed to the housing, the iron core having a plurality of mounting holes distributed spaced apart along a circumferential direction of the motor;
a winding which is mounted in the mounting holes and comprising extending parts extending from the iron core along an axial direction of the motor; and
seal rings located in the housing, the seal rings having end edges of two axial sides respectively abutting against the iron core and the covers, and an outer periphery of the seal rings abutting against the main body portion such that the seal rings, the main body portion, and the iron core define a space that is in communication with the mounting holes, the space continuously extending along the circumferential direction over the entire circumference, and the extending parts being accommodated in the space.

In an optional solution, the seal rings comprise a first seal ring and a second seal ring.

The first seal ring is located on one axial side of the iron core, and the first seal ring, the main body portion, and the iron core define the space located on the one axial side.

The second seal ring is located on the other axial side of the iron core, and the second seal ring, the main body portion, and the iron core define the space located on the other axial side.

The space located on the one axial side communicates with the space located on the other axial side via the mounting holes.

In another optional solution, the main body portion is formed with an inlet and an outlet. The inlet communicates with the space located on the one axial side, and the outlet communicates with the space located on the other axial side.

In another optional solution, when the axial direction is parallel to the horizontal plane, the inlet is formed at a lowermost part of the main body portion along the vertical direction, and the outlet is formed at an uppermost part of the main body portion along the vertical direction.

In another optional solution, the iron core is further formed with a plurality of passageways, the plurality of passageways are arranged spaced apart from the plurality of mounting holes, the plurality of passageways are distributed spaced apart along the circumferential direction, and the space located on the one axial side further communicates with the space located on the other axial side via the plurality of passageways.

In another optional solution, a peripheral portion of the seal rings is formed with a seal groove, and the seal groove is open towards the main body portion.

The motor further comprises seal gaskets, and the seal gaskets are made of an elastic material and accommodated in the seal groove so as to achieve a seal between the seal rings and the main body portion.

In another optional solution, the seal rings comprise an axial portion and a radial portion that are fixed to each other, the axial portion extends along the axial direction, one end edge of the axial portion abuts against the iron core, the radial portion extends from the other end edge of the axial portion towards a radially outer side, and the radial portion abuts against the covers.

In another optional solution, the radial portion comprises a plurality of abutting portions spaced apart along a radial direction of the motor, and the plurality of abutting portions protrude towards the covers to abut against the covers.

In another optional solution, the radial portion comprises a first thick-walled portion, a thin-walled portion, and a second thick-walled portion, the thickness of the first thick-walled portion is greater than the thickness of the thin-walled portion, the thickness of the second thick-walled portion is greater than the thickness of the thin-walled portion, the first thick-walled portion and the second thick-walled portion are located at two ends of the thin-walled portion, and the first thick-walled portion and the second thick-walled portion serve as the abutting portions.

The present application provides a vehicle power system comprising the motor according to any one of the preceding technical solutions.

By using the foregoing technical solutions, the present application provides a motor and a vehicle power system comprising the motor. In the motor of the present application, a stator is accommodated in a housing composed of a main body portion and covers, and the stator comprises an iron core and a winding that are assembled together. Further, the motor further comprises seal rings, the seal rings have end edges of two axial sides respectively abutting against the iron core and the covers, an outer periphery of the seal rings abuts against the main body portion, and thereby, the seal rings are limited by the iron core and the covers along an axial direction of the motor and limited by the main body portion along a radial direction. In this way, the seal rings, the main body portion, and the iron core define a space that is in communication with mounting holes of the iron core for mounting the winding, and the space continuously extends along a circumferential direction of the motor over the entire circumference. Thereby, extending parts of the winding extending from the iron core are accommodated in the space.

In this way, the seal rings achieve a stable structural coordination with the main body portion and the iron core, thereby defining the space between the seal rings, the main body portion, and the iron core to accommodate the extending parts of the winding. After the space is filled with a cooling fluid (e.g., a cooling oil), not only can the extending parts of the winding be immersed in the cooling fluid, but the cooling fluid can also flow from the space through a portion of the winding that is located in the mounting holes. In this way, the cooling fluid can directly cool both the entire winding and the iron core. Thus, the cooling structure of the motor of the present application can fully and effectively cool the stator, thereby reducing adverse effects on the performance of the motor caused by an over-high temperature of the stator in a working process of the motor.

### BRIEF DESCRIPTION OF THE DRAWINGS

FIG. 1 is a schematic cross-sectional view showing a structure of a motor according to an embodiment of the present application.

FIG. 2 is a schematic cross-sectional view showing a partial structure of the motor in FIG. 1.

FIG. 3 is a partial schematic structural diagram showing an assembly of both an iron core and a winding of the motor in FIG. 1.

FIG. 4 is a schematic diagram showing a structure of an iron core of the motor in FIG. 1.

FIG. 5 is a schematic diagram showing a partial structure of the iron core. in FIG. 4.

FIG. 6 is a schematic cross-sectional view showing a partial structure of a first seal ring of the motor in FIG. 1, where a dotted line represents the boundary position of an axial portion and a radial portion.

### DETAILED DESCRIPTION

Exemplary embodiments of the present application are described below with reference to the accompanying drawings. It should be understood that these specific descriptions are only used to teach those skilled in the art how to implement the present application, and are neither intended to be exhaustive of all possible implementations of the present application nor to limit the scope of the present application.

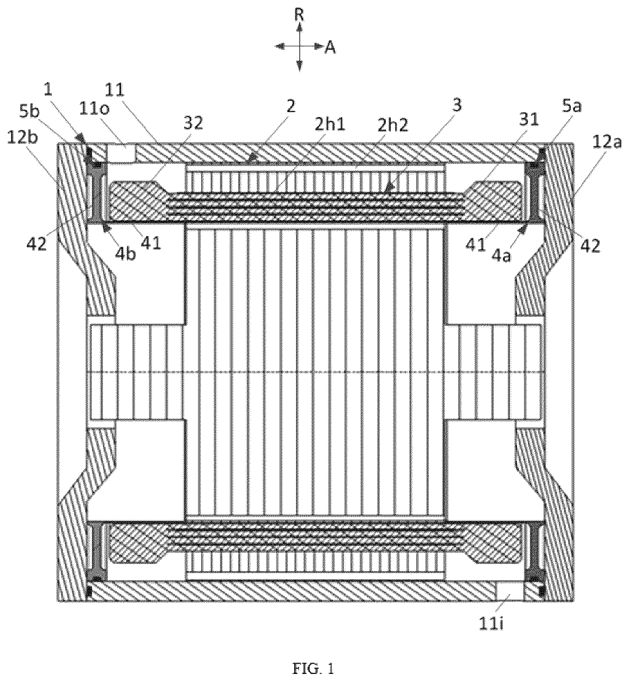

In the present application, unless otherwise stated, “axial direction”, “radial direction”, and “circumferential direction” refer to an axial direction, a radial direction, and a circumferential direction of a motor, respectively. “One axial side” refers to the right side in FIG. 1, and “the other axial side” refers to the left side in FIG. 1. “A radially outer side” refers to a side away from a central axis of the motor along a radial direction, and “a radially inner side” means a side close to the central axis of the motor along a radial direction.

The motor according to the present application comprises a housing, a stator, and a rotor. The stator and the rotor are arranged in a coaxial manner and are substantially in a space enclosed by the housing. The stator is fixed to the housing. The rotor is located on a radially inner side of the stator and is rotatable relative to the stator. There is an air gap between the rotor and the stator, and the rotor can be connected to a transmission mechanism via a rotor shaft. The motor is provided with a cooling structure for cooling the stator. In the cooling structure, by utilizing, for example, cooling oil as a cooling fluid, an iron core and a winding of the stator are cooled. Therefore, the motor according to the present application can be an oil-cooled motor.

A specific structure of a motor according to an embodiment of the present application will be further described below with reference to the accompanying drawings of the specification, particularly illustrating a cooling structure configured to cool a stator.

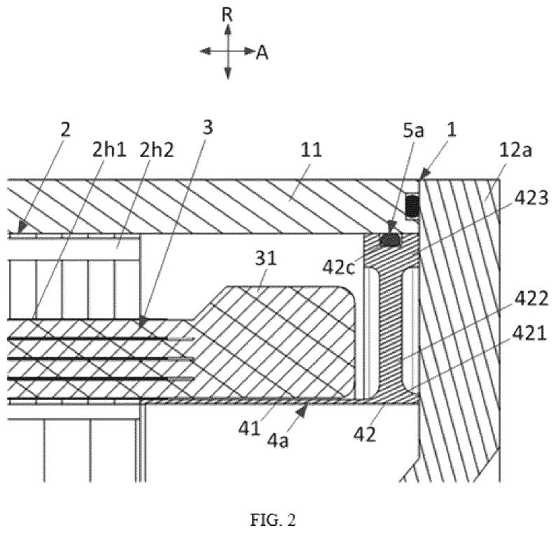

As shown in FIG. 1 and FIG. 2, a motor according to an embodiment of the present application comprises a housing 1, an iron core 2, a winding 3, two seal rings (a first seal ring 4a and a second seal ring 4b), and two seal gaskets (a first seal gasket 5a and a second seal gasket 5b) that are assembled together, wherein the iron core 2 and the winding 3 constitute a stator.

In this embodiment, as shown in FIG. 1 and FIG. 2, the housing 1 comprises a main body portion 11, a first cover 12a, and a second cover 12b that are assembled together. Specifically, the main body portion 11 has a cylindrical shape. The main body portion 11 is formed with a through-hole that can be passed through along an axial direction A, and the through-hole has an opening that is open towards two axial sides. The first cover 12a can be detachably fixed to the main body portion 11 by means of mechanical connection such as bolt connection. The first cover 12a closes an opening on one axial side of the main body portion 11, and a seal gasket for sealing is provided between the first cover 12a and the main body portion 11. The second cover 12b can be detachably fixed to the main body portion 11 by means of mechanical connection such as bolt connection. The second cover 12b closes an opening on the other axial side of the main body portion 11, and a seal gasket for sealing is provided between the second cover 12b and the main body portion 11. In this way, the main body portion 11, the first cover 12a, and the second cover 12b define an accommodation space inside the housing 1, and other components are essentially accommodated within the accommodation space.

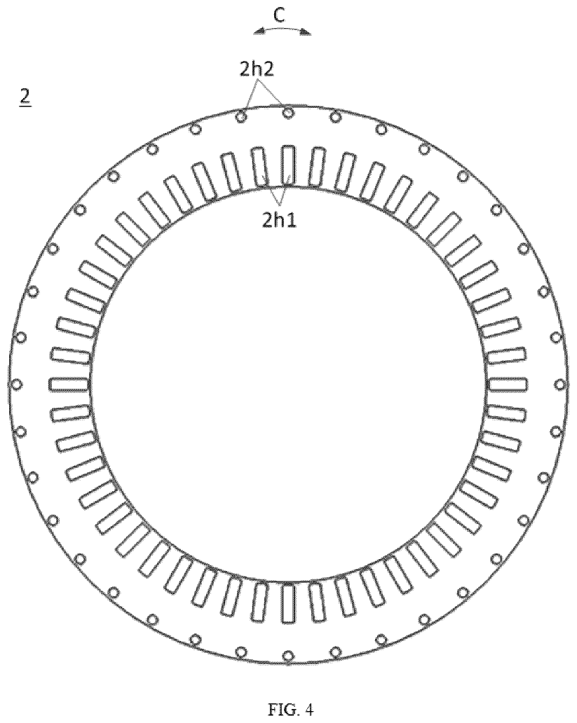

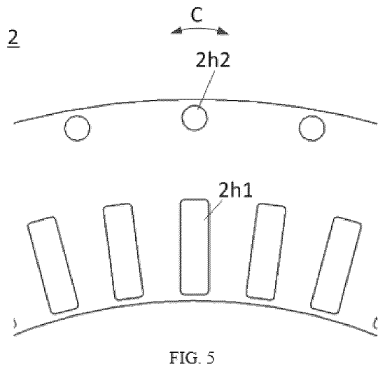

In this embodiment, as shown in FIG. 1 to FIG. 2, the iron core 2 is located in the housing 1 and is fixed to the housing 1. The iron core 2 can be formed by laminating a plurality of silicon steel sheets together along the axial direction A. Each of the silicon steel sheets can have a thickness of, for example, 0.25 mm to 0.5 mm and can be formed by stamping. As shown in FIG. 1 to FIG. 5, the iron core 2 has a cylindrical structure as a whole and the iron core 2 can be fixed to the main body portion 11 of the housing 1 through an interference fit. In this way, an outer peripheral surface of the iron core 2 is in close contact with an inner peripheral surface of the main body portion 11.

Further, as shown in FIG. 1 to FIG. 5, the iron core 2 is formed with a plurality of mounting holes 2h1 and a plurality of passageways 2h2, and the plurality of mounting holes 2h1 are used for inserting and mounting the winding 3. The plurality of passageways 2h2 are mainly used to connect spaces located on two axial sides of the iron core 2 such that the cooling fluid can flow between the spaces of the two axial sides of the iron core 2 mainly via the plurality of passageways 2h. The plurality of mounting holes 2h1 are located at the same part of the iron core 2 along a radial direction R, and the plurality of mounting holes 2h1 are uniformly distributed so as to be spaced apart along a circumferential direction C. Each mounting hole 2h1 extends linearly along the axial direction A and is only open at end faces of the two axial sides of the iron core 2, and each mounting hole 2h1 is closed along both the radial direction R and the circumferential direction C. The plurality of passageways 2h2 are separated from the plurality of mounting holes 2h1. The plurality of passageways 2h2 can be located at the same part of the iron core 2 along the radial direction R and located on radially outer sides of the plurality of mounting holes 2h1. The plurality of passageways 2h2 are uniformly distributed so as to be spaced apart along the circumferential direction C. Each passageway 2h2 extends linearly along the axial direction A and is only open at the end faces of the two axial sides of the iron core 2, and each passageway 2h2 is closed along both the radial direction R and the circumferential direction C. It can be understood that the arrangement of the foregoing passageways 2h2 is exemplary only and not restrictive. For example, the plurality of passageways can alternatively be provided at different parts along the radial direction R of the iron core 2.

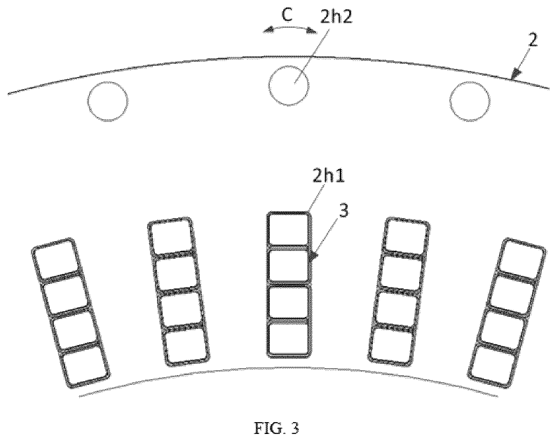

In this embodiment, the winding 3 can be formed by connecting a plurality of hairpin windings together. As shown in FIG. 1 to FIG. 3, a central portion of the winding 3 is inserted and mounted in the mounting holes 2h1 of the iron core 2, the central portion of the winding 3 is divided into four layers in each mounting hole 2h1 (with reference to FIG. 3), and each layer can comprise one wire conductor with a rectangular cross-section. In each mounting hole 2h1, there are gaps between adjacent wire conductors and between the wire conductor and the iron core 2, and these gaps allow the mounting holes 2h1 to be passed through along the axial direction A for the cooling fluid. An end portion of the winding 3 located on two axial sides of the central portion of the winding extends from the iron core 2 along the axial direction A. In this way, the winding 3 comprises a first extending part 31 located on one axial side and a second extending part 32 located on the other axial side.

In this embodiment, the first seal ring 4a and the second seal ring 4b can be made of an insulating material. As shown in FIG. 1 and FIG. 2, both the first seal ring 4a and the second seal ring 4b are located in the housing 1 and fixed to the housing 1. End edges of two axial sides of the first seal ring 4a respectively abut against an end face on one axial side of the iron core 2 and the first cover 12a, and an outer periphery of the first seal ring 4a abuts against the inner peripheral surface of the main body portion 11 such that the first seal ring 4a, the main body portion 11, and the iron core 2 define a first space that is in communication with the mounting holes 2h1. The first space continuously extends along the circumferential direction C over the entire circumference, and the first extending part 31 of the winding 3 is accommodated in the first space. End edges of two axial sides of the second seal ring 4b respectively abut against an end face on the other axial side of the iron core 2 and the second cover 12b, and an outer periphery of the second seal ring 4b abuts against the inner peripheral surface of the main body portion 11 such that the second seal ring 4b, the main body portion 11, and the iron core 2 define a second space that is in communication with the mounting holes 2h1. The second space continuously extends along the circumferential direction C over the entire circumference, and the second extending part 32 of the winding 3 is accommodated in the second space. In this way, the first space and the second space located on the two axial sides of the iron core 2 can communicate via the plurality of mounting holes 2h1 and the plurality of passageways 2h2 such that the cooling fluid can flow in the first space, the second space, the plurality of mounting holes 2h1, and the plurality of passageways 2h2.

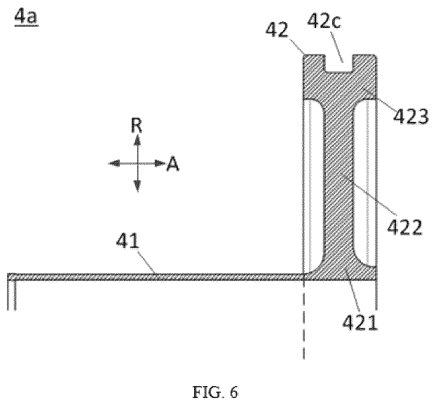

Further, the first seal ring 4a and the second seal ring 4b can have the same structure. The first seal ring 4a will be used as an example to illustrate a structure of the seal ring. The first seal ring 4a is integrally formed in an annular shape. As shown in FIG. 1, FIG. 2, and FIG. 6, the first seal ring 4a comprises an axial portion 41 and a radial portion 42 that are formed as a whole. The axial portion 41 extends along the axial direction A, and an end edge of the other axial side of the axial portion 41 abuts against the end face on the one axial side of the iron core 2. The radial portion 42 extends from an end edge of one axial side of the axial portion 41 towards a radially outer side along the radial direction R. Further, as shown in FIG. 2 and FIG. 6, the radial portion 42 comprises a first thick-walled portion 421, a thin-walled portion 422, and a second thick-walled portion 423 along the radial direction R. The thickness of the first thick-walled portion 421 (a dimension along the axial direction A) is greater than the thickness of the thin-walled portion 422, the thickness of the second thick-walled portion 423 is greater than the thickness of the thin-walled portion 422, and the thickness of the first thick-walled portion 421 can be equal to the thickness of the second thick-walled portion 423. The first thick-walled portion 421 is located at an end on a radially inner side of the thin-walled portion 422, and the second thick-walled portion 423 is located at an end on a radially outer side of the thin-walled portion 422. The first thick-walled portion 421 and the second thick-walled portion 423 serve as an abutting portion for the radial portion 42 to abut against the first cover 12a along the axial direction A such that an end face on one axial side of the first thick-walled portion 421 and an end face on one axial side of the second thick-walled portion 423 abut against the first cover 12a. A peripheral portion of the radial portion 42 is formed with a seal groove 42c, and the seal groove 42c is open towards the main body portion 11 of the housing 1. The first seal gasket 5a is made of an elastic material such as rubber and is accommodated in the seal groove 42c so as to achieve a seal between the first seal ring 4a and the main body portion 11. The second seal ring 4b has a structure symmetrical to the first seal ring 4a. The second seal gasket 5b is made of an elastic material such as rubber and is accommodated in the seal groove 42c of the second seal ring 4b so as to achieve a seal between the second seal ring 4b and the main body portion 11. Further, both the first seal ring 4a and the second seal ring 4b can be fixedly mounted to the housing 1 through an interference fit between the radial portion 42 and the main body portion 11 of the housing 1.

In this way, along the axial direction A, the first cover 12a and the main body portion 11 limit the first seal ring 4a, the second cover 12b and the main body portion 11 limit the second seal ring 4b, and the main body portion 11 limits the first seal ring 4a and the second seal ring 4b along the radial direction R, so that the first seal ring 4a and the second seal ring 4b can be mounted in place reliably and stably. Further, since both the first seal ring 4a and the second seal ring 4b are provided with thin-walled portions 422, the quality of the seal ring 4a and the seal ring 4b can be reduced, while the thick-walled portion 421 and the thick-walled portion 423 that are spaced apart along the radial direction R serve as abutting portions such that the reliability and stability of the mounting of the first seal ring 4a and the second seal ring 4b can be improved.

In addition, as shown in FIG. 1, the main body portion 11 of the housing 1 is formed with an inlet 11i and an outlet 110. The inlet 11i communicates with a space located on one axial side and the outlet 110 communicates with a space located on the other axial side. When the axial direction A is parallel to the horizontal plane, the inlet 11i can be formed at a lowermost part of the main body portion 11 along the vertical direction, and the outlet 110 is formed at an uppermost part of the main body portion 11 along the vertical direction. In this way, it is beneficial for the cooling fluid entering the first space via the inlet 11i to fill the first space, the second space, and the plurality of mounting holes 2h1 and the plurality of passageways 2h2 that connect the two spaces. Thus, the motor according to an embodiment of the present application forms a cooling flow path using the inlet 11i, the first space, the plurality of mounting holes 2h1, the plurality of passageways 2h2, the second space, and the outlet 110, where the cooling fluid flows through the cooling flow path to cool the stator.

Further, since the first extending part 31 of the winding 3 is always located in the first space, the first extending part 31 of the winding 3 can be immersed in the cooling fluid in the first space, and the cooling fluid can directly cool the first extending part 31 of the winding 3. Since the second extending part 32 of the winding 3 is always located in the second space, the second extending part 32 of the winding 3 can be immersed in the cooling fluid in the second space, and the cooling fluid can directly cool the second extending part 32 of the winding 3. In addition, the cooling fluid further flows through the plurality of mounting holes 2h1 such that the cooling fluid can directly cool the central portion of the winding 3. Further, the cooling fluid flows through not only the plurality of mounting holes 2h1 but also the plurality of passageways 2h2 such that the cooling fluid can directly cool the iron core 2. Thus, the cooling structure of the motor can fully and effectively cool the stator of the motor, thereby reducing adverse effects on performance of the motor caused by an over-high temperature of the stator in a working process of the motor.

It should be understood that the foregoing embodiments are exemplary only and are not intended to limit the present application. Those skilled in the art can make various modifications and changes to the foregoing embodiments according to the teaching of the present application without departing from the scope of the present application. Supplementary description of the technical solutions of the present application is provided below.
i. In the present application, a vehicle power system is further provided, and the vehicle power system can be an electric bridge drive system or a hybrid system. The vehicle power system according to the present application can further comprise transmission mechanisms such as a transmission in addition to the motor of the present application. The motor is drivingly connected to an input shaft of the transmission to achieve bidirectional torque transfer.
ii. In the technical solution of the motor of the present application, an oil supply system that is in communication with the inlet 11i can be provided outside the housing 1 of the motor. The oil supply system can comprise a pump, an oil passage (oil pipe), and the like such that a cooling oil serving as the cooling fluid can be supplied by the oil supply system. In addition, the outlet 11o can also communicate with the transmission such that the cooling fluid after cooling the stator can be returned to a housing of the transmission.
iii. It can be understood that in an optional technical solution of the present application, a space for immersing the extending part of the winding 3 in the cooling fluid can be formed only on one axial side of the iron core 2 with the inlet 11i provided at the uppermost portion of the space, which can likewise achieve effective cooling of the stator.
iv. It can be understood that in an optional technical solution of the present application, the radial portions 42 of the seal ring 4a and the seal ring 4b of the present application can comprise more than two abutting portions, and these abutting portions can be spaced apart along the radial direction R of the motor. These abutting portions protrude towards the cover 12a and the cover 12b to abut against the cover 12a and the cover 12b of the housing 1 of the motor. In addition, the seal ring 4a and the seal ring 4b of the present application have a simple structure and can be easily mounted.

### LIST OF REFERENCE NUMERALS

1 Housing;
11 Main body portion;
11i Inlet;
11o Outlet;
12a First cover;
12b Second cover;
2 Iron core;
2h1 Mounting holes;
2h2 Passageways;
3 Winding;
31 First extending part;
32 Second extending part;
4a First seal ring;
4b Second seal ring;
41 Axial portion;
42 Radial portion;
42c Seal groove;
421 First thick-walled portion;
422 Thin-walled portion;
423 Second thick-walled portion;
5a First seal gasket;
5b Second seal gasket;
A Axial direction;
R Radial direction;
C Circumferential direction

1. A motor, comprising:
a housing comprising a main body portion and covers, the main body portion having a cylindrical shape, and the covers being fixed to the main body portion and closing an axial opening of the main body portion;
an iron core being located in the housing and fixed to the housing, the iron core having a plurality of mounting holes spaced apart along a circumferential direction of the motor;
a winding being mounted in the mounting holes and comprising extending parts extending from the iron core along an axial direction of the motor; and
a plurality of seal rings being located in the housing, the seal rings having end edges of two axial sides respectively abutting against the iron core and the covers, and an outer periphery of the seal rings abutting against the main body portion such that the seal rings, the main body portion, and the iron core define a space that is in communication with the mounting holes, the space continuously extending along the circumferential direction over the entire circumference, and the extending parts being accommodated in the space.

2. The motor according to claim 1, wherein the seal rings comprise a first seal ring and a second seal ring;
the first seal ring is located on one axial side of the iron core, and the first seal ring, the main body portion, and the iron core define the space located on the one axial side;
the second seal ring is located on the other axial side of the iron core, and the second seal ring, the main body portion, and the iron core define the space located on the other axial side; and
the space located on the one axial side communicates with the space located on the other axial side via the mounting holes.

3. The motor according to claim 2, wherein the main body portion is formed with an inlet and an outlet, the inlet communicates with the space located on the one axial side, and the outlet communicates with the space located on the other axial side.

4. The motor according to claim 3, wherein when the axial direction is parallel to the horizontal plane, the inlet is formed at a lowermost part of the main body portion along the vertical direction, and the outlet is formed at an uppermost part of the main body portion along the vertical direction.

5. The motor according to claim 2, wherein the iron core is further formed with a plurality of passageways, the plurality of passageways are arranged spaced apart from the plurality of mounting holes, the plurality of passageways are distributed spaced apart along the circumferential direction, and the space located on the one axial side further communicates with the space located on the other axial side via the plurality of passageways.

6. The motor according to claim 1, wherein a peripheral portion of the seal rings is formed with a seal groove, and the seal groove is open towards the main body portion; and
the motor further comprises seal gaskets, and the seal gaskets are made of an elastic material and accommodated in the seal groove so as to achieve a seal between the seal rings and the main body portion.

7. The motor according to claim 1, wherein the seal rings comprise an axial portion and a radial portion that are fixed to each other, the axial portion extends along the axial direction, one end edge of the axial portion abuts against the iron core, the radial portion extends from the other end edge of the axial portion towards a radially outer side, and the radial portion abuts against the covers.

8. The motor according to claim 7, wherein the radial portion comprises a plurality of abutting portions spaced apart along a radial direction of the motor, and the plurality of abutting portions protrude towards the covers to abut against the covers.

9. The motor according to claim 8, wherein the radial portion comprises a first thick-walled portion, a thin-walled portion, and a second thick-walled portion, the thickness of the first thick-walled portion is greater than the thickness of the thin-walled portion, the thickness of the second thick-walled portion is greater than the thickness of the thin-walled portion, the first thick-walled portion and the second thick-walled portion are located at two ends of the thin-walled portion, and the first thick-walled portion and the second thick-walled portion serve as the abutting portions.

10. A vehicle power system, comprising the motor according to claim 1.

11. A motor comprising:
a housing comprising a main body portion and covers, the main body portion having a cylindrical shape, and the covers fixed to the main body portion and closing an axial opening of the main body portion;
an iron core located in the housing and fixed to the housing, the iron core having a plurality of mounting holes spaced apart along a circumferential direction of the motor;
a winding mounted in the mounting holes and comprising extending parts extending from the iron core along an axial direction of the motor; and
a plurality of seal rings located in the housing, the seal rings having end edges of two axial sides respectively abutting against the iron core and the covers, and an outer periphery of the seal rings abutting against the main body portion such that the seal rings,
wherein the seal rings comprise a first seal ring and a second seal ring,
wherein the first seal ring is located on one axial side of the iron core, and the first seal ring, the main body portion, and the iron core define a space located on the one axial side,
wherein the second seal ring is located on the other axial side of the iron core, and the second seal ring, the main body portion, and the iron core define a space located on the other axial side,
wherein the space located on the one axial side communicates with the space located on the other axial side via the mounting holes,
wherein a peripheral portion of the seal rings is formed with a seal groove, and the seal groove is open towards the main body portion.

12. The motor according to claim 11, wherein the main body portion is formed with an inlet and an outlet, the inlet communicates with the space located on the one axial side, and the outlet communicates with the space located on the other axial side.

13. The motor according to claim 12, wherein when the axial direction is parallel to the horizontal plane, the inlet is formed at a lowermost part of the main body portion along the vertical direction, and the outlet is formed at an uppermost part of the main body portion along the vertical direction.

14. The motor according to claim 12, wherein the iron core is further formed with a plurality of passageways, the plurality of passageways are arranged spaced apart from the plurality of mounting holes, the plurality of passageways are distributed spaced apart along the circumferential direction, and the space located on the one axial side further communicates with the space located on the other axial side via the plurality of passageways.

15. The motor according to claim 11, wherein the motor further comprises seal gaskets, and the seal gaskets are made of an elastic material and accommodated in the seal groove so as to achieve a seal between the seal rings and the main body portion.

16. The motor according to claim 11, wherein the seal rings comprise an axial portion and a radial portion that are fixed to each other, the axial portion extends along the axial direction, one end edge of the axial portion abuts against the iron core, the radial portion extends from the other end edge of the axial portion towards a radially outer side, and the radial portion abuts against the covers.

17. The motor according to claim 16, wherein the radial portion comprises a plurality of abutting portions spaced apart along a radial direction of the motor, and the plurality of abutting portions protrude towards the covers to abut against the covers.

18. The motor according to claim 17, wherein the radial portion comprises a first thick-walled portion, a thin-walled portion, and a second thick-walled portion, the thickness of the first thick-walled portion is greater than the thickness of the thin-walled portion, the thickness of the second thick-walled portion is greater than the thickness of the thin-walled portion, the first thick-walled portion and the second thick-walled portion are located at two ends of the thin-walled portion, and the first thick-walled portion and the second thick-walled portion serve as the abutting portions.

19. A vehicle power system comprising:
a transmission; and
a motor, wherein the motor is coupled to an input shaft of the transmission, wherein the motor comprises:
a housing comprising a main body portion and covers, the main body portion having a cylindrical shape, and the covers being fixed to the main body portion and closing an axial opening of the main body portion;
an iron core being located in the housing and fixed to the housing, the iron core having a plurality of mounting holes spaced apart along a circumferential direction of the motor;
a winding being mounted in the mounting holes and comprising extending parts extending from the iron core along an axial direction of the motor; and
a plurality of seal rings being located in the housing, the seal rings having end edges of two axial sides respectively abutting against the iron core and the covers, and an outer periphery of the seal rings abutting against the main body portion such that the seal rings, the main body portion, and the iron core define a space that is in communication with the mounting holes, the space continuously extending along the circumferential direction over the entire circumference, and the extending parts being accommodated in the space.

20. The vehicle power system according to claim 19, wherein the motor and transmission are configured as part of an electric bridge drive system or a hybrid system.
